(19) United States
(12) Patent Application Publication
(10) Pub. No.: US 2013/0200614 A1
(43) Pub. Date: Aug. 8, 2013

(54) Device for pivotably connecting hydraulic line to hydraulic brake of bicycle

(71) Applicant: Szu-Fang Tsai, Changhua (TW)

(72) Inventor: Szu-Fang Tsai, Changhua (TW)

(21) Appl. No.: 13/411,627

(22) Filed: Mar. 5, 2012

(30) Foreign Application Priority Data
Feb. 8, 2012 (TW) 101202255

(51) Int. Cl. F16L 19/00

(52) U.S. Cl. 285/351

(57) ABSTRACT

A device for pivotably connecting a hydraulic line to a hydraulic brake of bicycle is provided an adapter including a connector coupled to the hydraulic line, and a hollow cylinder at one end of the connector, the cylinder including a tunnel and two shoulders each at a joining portion of either end of the tunnel and adjacent end of the cylinder, a first sealing ring at one shoulder, and a second sealing ring at the other shoulder; and a stepped-diameter threaded fastener including a head, a threaded shank distal the head, and a bare cylindrical section between the head and the threaded shank, the threaded fastener driven through the tunnel into the hydraulic brake to fasten the threaded fastener, the adapter, the first sealing ring, and the second sealing ring together. The adapter can either counterclockwise or clockwise pivot a predetermined angle about the threaded fastener.

### BACKGROUND OF THE INVENTION

1. Field of the Invention

The invention relates to bicycle brakes and more particularly to a device for pivotably connecting a hydraulic line to a hydraulic brake (e.g, hydraulic disc brake) of a bicycle.

2. Description of Related Art

A conventional device for connecting a hydraulic line to a hydraulic brake (e.g, hydraulic disc brake) of a bicycle is characterized below. An adapter is formed at one end of the hydraulic line near a wheel. The adapter comprises an internally threaded channel. A threaded fastener is driven through the channel into the hydraulic disc brake. Thus, the adapter (i.e., one end of the hydraulic line) and the hydraulic disc brake are secured together.

However, the conventional device suffers from a drawback as detailed below. It is often that a rider has to adjust angle of the adapter with respect to the hydraulic disc brake if at least one of the adapter and the hydraulic disc brake needs to be replaced. Unfortunately, the fixed connection of the adapter (i.e., one end of the hydraulic line) and the hydraulic disc brake does not allow the angle adjustment after replacement. Thus, the need for improvement still exists.

### SUMMARY OF THE INVENTION

It is therefore one object of the invention to provide a connection device for a bicycle having a hydraulic line and a hydraulic brake, comprising an adapter comprising a connector coupled to the hydraulic line, and a hollow cylinder at one end of the connector, the cylinder including a tunnel and two shoulders each formed at a joining portion of either end of the tunnel and adjacent end of the cylinder, a first sealing ring disposed at one shoulder, and a second sealing ring disposed at the other shoulder; and a stepped-diameter threaded fastener comprising a head, a threaded shank spaced from the head, and a bare cylindrical section between the head and the threaded shank, the threaded fastener being driven through the tunnel into the hydraulic brake to fasten the threaded fastener, the adapter, the first sealing ring, and the second sealing ring together, wherein the adapter can either counterclockwise pivot a predetermined angle about the threaded fastener or clockwise pivot the predetermined angle about the threaded fastener.

The above and other objects, features and advantages of the invention will become apparent from the following detailed description taken with the accompanying drawings.

### BRIEF DESCRIPTION OF THE DRAWINGS

FIG. 1 is an exploded view of a device for pivotably connecting a hydraulic line to a hydraulic brake of a bicycle according to the invention;

FIG. 2 is a longitudinal sectional view of the device installed on a hydraulic disc brake;

FIG. 3 is a side elevation of a portion of FIG. 2;

FIG. 4 is a view similar to FIG. 3 showing a counterclockwise rotation of the adapter about the threaded fastener; and

FIG. 5 is a view similar to FIG. 3 showing a clockwise rotation of the adapter about the threaded fastener.

### DETAILED DESCRIPTION OF THE INVENTION

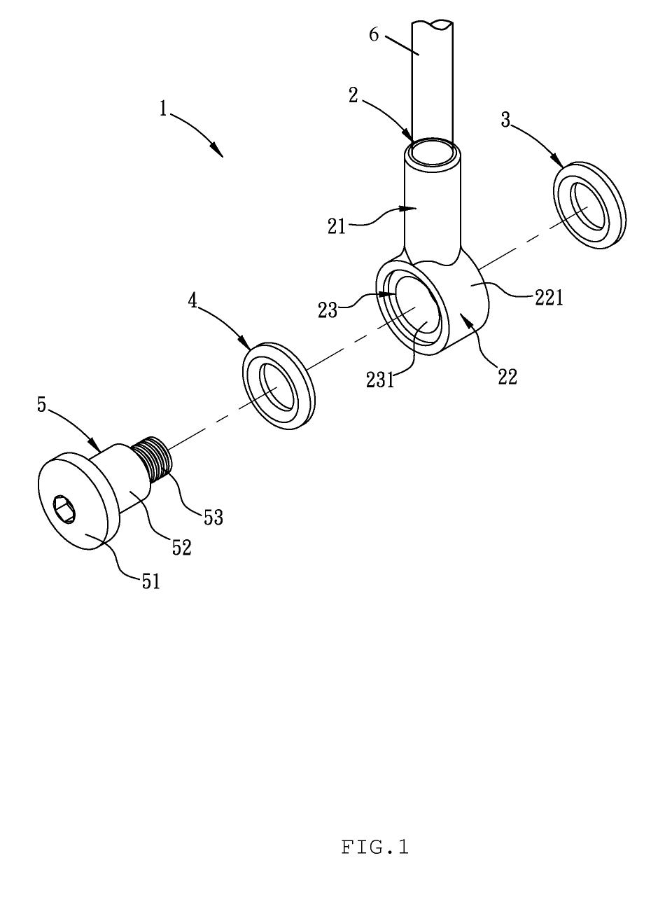

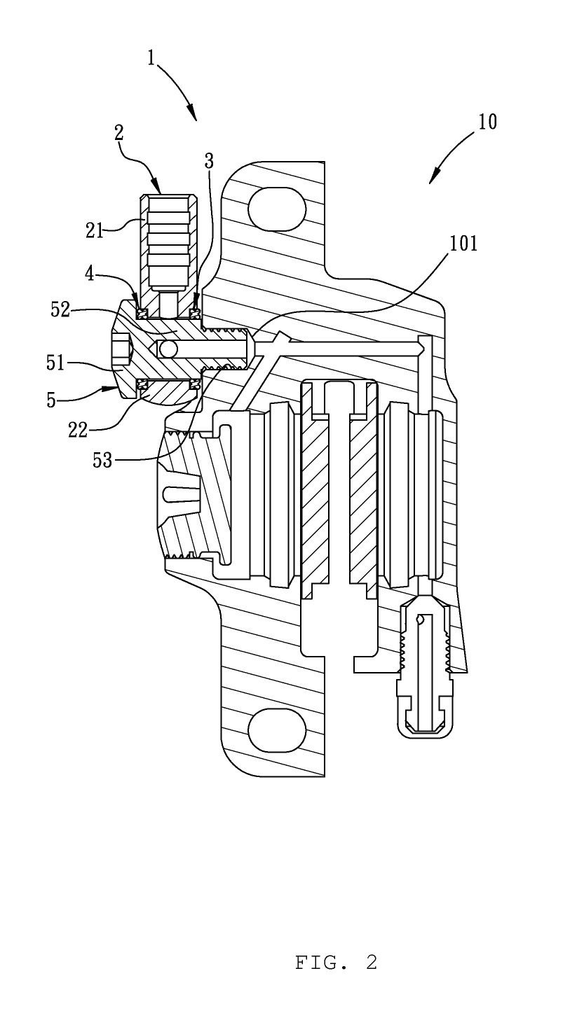

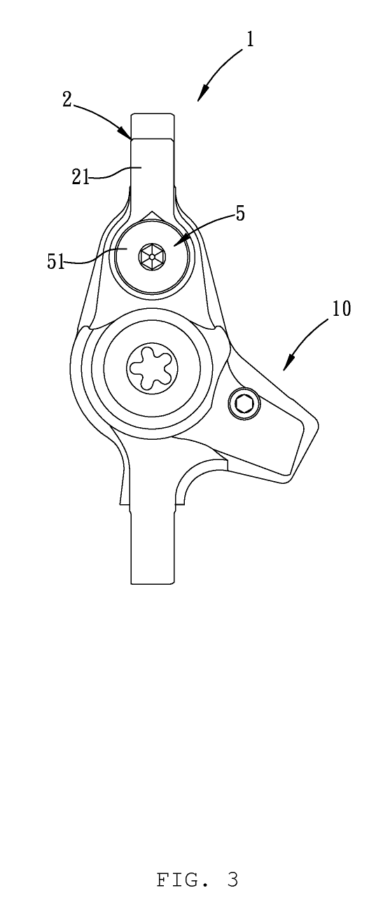

Referring to FIGS. 1 to 5, a device 1 for pivotably connecting a hydraulic line 6 to a hydraulic brake (e.g., hydraulic disc brake) 10 of a bicycle in accordance with the invention comprises the following components as discussed in detail below.

An adapter 2 comprises a cylindrical connector 21 coupled to the hydraulic line 6, and a hollow, enlarged cylinder 22 formed at one end of the connector 21, the cylinder 22 having a smooth outer surface 221 and including a tunnel 231 and two shoulders 23 (only one is shown in FIG. 1) each formed at a joining portion of either end of the tunnel 231 and adjacent end of the cylinder 22. A first sealing ring (e.g., O-ring) 3 disposed at one shoulder 23 and a second sealing ring (e.g., O-ring) 4 disposed at the other shoulder 23. A stepped-diameter threaded fastener 5 comprises an enlarged head 51, a threaded shank 53 spaced from the head 51, and a bare cylindrical section 52 interconnecting the head 51 and the shank 53. The threaded fastener 5 is driven through the tunnel 231 into the hydraulic disc brake 10 to fasten the threaded fastener 5, the adapter 2, the first sealing ring 3, and the second sealing ring 4 together. Also, the bare cylindrical section 52 is rotatably disposed in the tunnel 231.

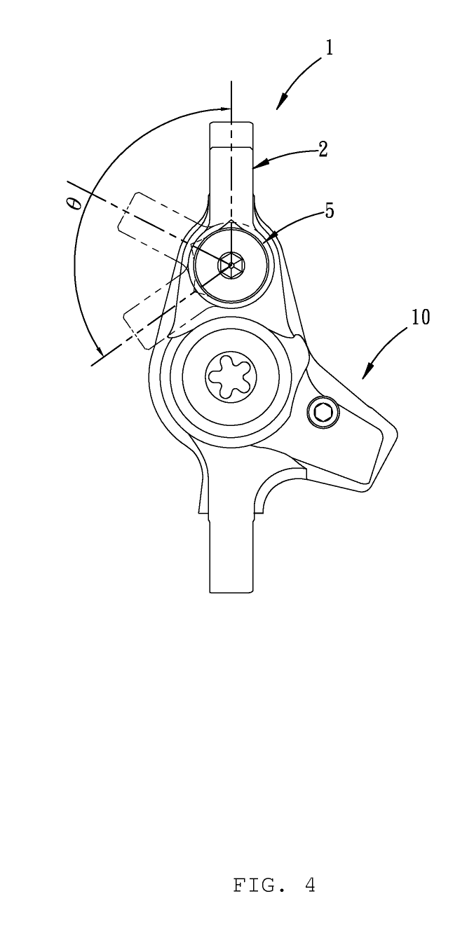

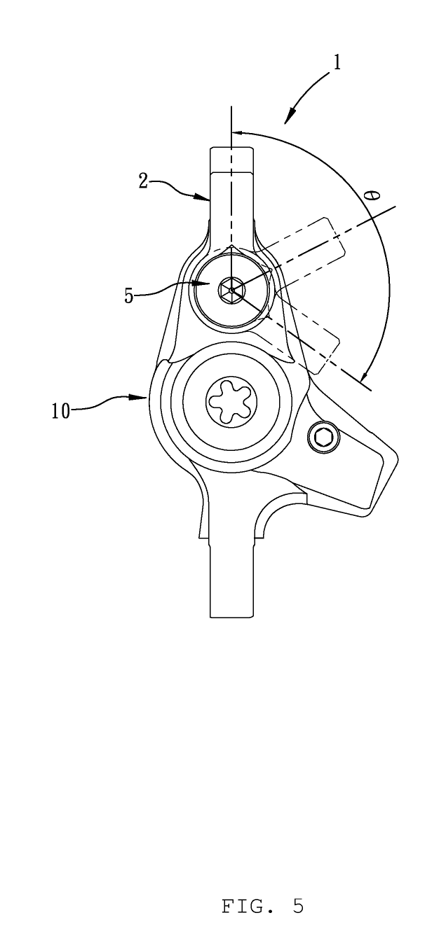

It is envisaged by the invention that the adapter 2 is adapted to either counterclockwise pivot an angle θ about the threaded fastener 5 (see FIG. 4) or clockwise pivot an angle θ about the threaded fastener 5 (see FIG. 5). In brief, the invention allows a rider to easily adjust angle of the adapter 2 with respect to the threaded fastener 5. This is particularly beneficial after component (e.g., the hydraulic disc brake 10) replacement.

While the invention has been described in terms of preferred embodiments, those skilled in the art will recognize that the invention can be practiced with modifications within the spirit and scope of the appended claims.

What is claimed is:

1. A connection device for a bicycle having a hydraulic line and a hydraulic brake, comprising:
an adapter comprising a connector coupled to the hydraulic line, and a hollow cylinder at one end of the connector, the cylinder including a tunnel and two shoulders each formed at a joining portion of either end of the tunnel and adjacent end of the cylinder, a first sealing ring disposed at one shoulder, and a second sealing ring disposed at the other shoulder; and
a stepped-diameter threaded fastener comprising a head, a threaded shank spaced from the head, and a bare cylindrical section between the head and the threaded shank, the threaded fastener being driven through the tunnel into the hydraulic brake to fasten the threaded fastener, the adapter, the first sealing ring, and the second sealing ring together,
wherein the bare cylindrical section is rotatably disposed in the tunnel; and
wherein the adapter either counterclockwise pivots a predetermined angle about the threaded fastener or clockwise pivots the predetermined angle about the threaded fastener.
